(19) United States
(12) Patent Application Publication
(10) Pub. No.: US 2013/0191196 A1
(43) Pub. Date: Jul. 25, 2013

(54) System and Method for Utilizing Consumer Capital to fund Municipal Charitable Projects

(71) Applicant: Arthur Cecala, Mesa, AZ (US)

(72) Inventor: Arthur Cecala, Mesa, AZ (US)

(21) Appl. No.: 13/750,278

(22) Filed: Jan. 25, 2013

Related U.S. Application Data
(60) Provisional application No. 61/590,482, filed on Jan. 25, 2012.

(51) Int. Cl. G06Q 30/02

(52) U.S. Cl. CPC G06Q 30/0279
USPC 705/14.17; 705/21; 705/17; 705/35

(57) ABSTRACT

A consumer capital distribution system for providing revenue to underfunded municipal projects and charitable organizations. Consumers are provided with a member card that is linked to a charity of their choice, and a consumer loyalty program that retains store credits for any participating retailers the consumer patronizes. When the consumer makes a purchase at t participating business, a first portion of the purchase price is donated by the business to the consumer's selected charity; a second portion is contribution to a participating business retirement plan fund; and a third portion is attributed to the consumer's loyalty program account as a store credit. The system is administered by an administrative entity that enrolls new consumers, businesses and charities, and tracks the account details and donation history of each. The system and method thus help municipalities to provide revenue to projects that would otherwise go unfunded.

### CROSS REFERENCE TO RELATED APPLICATION

This application claims the benefit of U.S. Provisional Application No. 61/509,482 filed on Jan. 25, 2012, entitled “Capitol Action Program.” The above identified patent application is herein incorporated by reference in its entirety to provide continuity of disclosure.

### BACKGROUND OF THE INVENTION

1. Field of the Invention

The present invention relates to a system and a method for using consumer transactions to establish capital infusions for municipal and community charitable organizations and guaranteed benefit assets for local product and service providers. More specifically, the present invention uses consumer transactions at local businesses to create donative capital streams for charitable organizations and a retirement for the local business from which the purchase was made.

Municipal governments often struggle to raise revenue sufficient to fund government projects and services. Schools, administrative bodies, police, homeless shelters, and other essential services, all require substantial portions of a municipality's yearly budget. Taxes, e the primary source of revenue for most municipalities, are commonly collected from income and sales. As the municipality grows, tax revenue increases, as does the demand for essential public services. Thus, ancillary municipal projects often go underfunded regardless of the population size of the municipality. For example, parks and recreation, disability services, and after school programs may be cut when funding runs out or is required by essential services. Creative solutions to underfunding problems often go unexplored because they involve modification to municipal operations and the expenditure of resources.

Private sector entities also regularly suffer from an inability to fund benefits programs. Pension programs and 401(k) plans are not available to the employees of many small businesses because the programs are too costly. Employers lack the excess revenue necessary to incorporate long-term investment assets into the benefits packages they provide their employees. Similarly, businesses often make minor donations of time or money to local charities and community projects, but find it difficult to set aside revenue for continuous charitable sponsorship.

When municipal and community projects are properly funded, the quality of life increases. Park improvements provide green spaces for children to play; disability services provide handicapped children and adults with the assistance they need to succeed in school and employment. After school care reduces the number of children who are unsupervised after school ends. Police pension funds provide a benefit to service members who risked their lives to protect the community. Though these services are not essential, they help make life easier for parents and the disabled, improve the environment, and incentivize community members to join public service. Municipal projects are thus an important part of a high quality of life and should be funded if at all possible.

Community members play an important role in maintaining municipal programs. Not only are they the primary source of tax revenue, but they provide valuable feedback to administrative bodies about their needs, and donate their time to assisting with local projects and charitable organizations. Despite the wealth of human capital that exists within the geographical area, municipalities often do not effectively communicate with community members about how they can help underfunded programs. The potential for reduced governmental expenditure due to community member donations of time and money is not seized, because of a breakdown in communication and administrative oversight. A system is needed for redirecting a portion of community member expenditures to municipal programs and benefits for local business employees.

2. Description of the Prior Art

The present invention provides a system and a method for funding municipal projects, charitable organizations, and benefits for small business employees. An administrative system interacts with local businesses, consumers, charitable organizations and municipal programs, and various financial institutions, to create a revenue flow from consumers to pension funds and charitable organizations or municipal programs. Consumers are provided with a machine-readable card that is used when making purchases at local businesses. A portion of the purchase price is sent to a pension fund for the business, a portion is sent to one or more charitable organizations of the consumer's choosing, and a portion is retained on the consumer's card for credit towards later purchases at the local business. In this way, consumer transactions are used to create a capital flow into underfunded projects and business employee benefits. The prior art discloses a number of financial vehicles for project funding, annuity products, and consumer rewards programs, but the art does not teach a system that uses a purchase rewards program to provide capital to charitable organizations, nor do they disclose a benefit plan for participating businesses.

Charitable donation rewards programs utilize a consumer identifier to divert funds to charitable organizations. Cards or other member indicia are issued to a consumer for use when making purchases. The card is presented to a retailer at the time of a purchase, and a portion of the purchase price is donated to a charitable organization. Kane, U.S. Patent Application Publication No. 2012/0323780 discloses a card displaying member indicia and linked to a member's financial institution. The card has a magnetic strip on one side, for swiping during a transaction. When a purchase is made, the financial institution debts funds from the user's account and transfers a pre-determined portion of the cost to a charity. Kane does not teach distribution of a portion of the purchase price to a consumer's card as a credit for later use at the same retailer

Alternatively, the donation reward may be in the form of a loyalty program. Hakim, U.S. Pat. No. 8,249,884 teaches a loyalty system wherein a consumer signs up for the loyalty program and presents membership indicia to a business during a purchase transaction. At the point of sale, the consumer can stipulate the portion of the purchase that should be donated and the receiving institution(s). This program differs from Kane in that the card is merely an identifier for linking the consumer's purchase to the consumer's preference in an administrative system, while the Kane system involves a card that is directly linked to the consumer's financial institution. Neither Kane nor Hakim addresses the additional consumer incentive of providing consumers with a credit to the same retailer at which the purchase was made. Nor do they disclose benefits programs for the merchant.

Employee benefits programs such as pension plans and healthcare plans have been used by employers for many years. These plans provide loyal employees with a reward after a fixed period of service or upon the attaining of a pre-determined age. Weis, U.S. Pat. No. 7,949,601 discloses a method for administering a guaranteed annuity plan, wherein a contract price is agreed upon and users pay in over time until the contract price is reached or exceeded. Exceeding the pre-determined payment amounts results in a higher annuity benefit, but the benefit cannot drop below the guaranteed contract price. Employees or the employer can pay into the benefit plan over time and are guaranteed to receive a benefit later. Another annuity plan, specifically addressing sponsor contributions is disclosed in Stiff, U.S. Pat. No. 8,024,248. Similarly, health plans provided by an Insurer to Employees of a company are described in Spriggs, U.S. Patent Application Publication No. 2010/0094663. Health plan options are provided to the employees and the selected plan is administered by the insurer. Employers pay for a portion of the health plan costs as a benefit to their employees. None of these patents discloses the use of benefits programs in a system for funding charitable organizations through consumer purchases. The present invention provides businesses with benefits programs as an incentive to participate in the program.

The prior art suffers from several drawbacks in that it does not contemplate a comprehensive system for funding community projects and organizations, while benefiting the businesses who donate to the same. The present invention provides a system and method for using consumer purchases to fund community projects and establish present and long-term benefits for employees of local businesses. It substantially diverges in design elements from the prior art and consequently it is clear that there is a need in the art for an improvement to existing fundraising systems and methods. In this regard the instant invention substantially fulfills these needs.

### SUMMARY OF THE INVENTION

In view of the foregoing disadvantages inherent in the known types of charitable fundraising systems and methods now present in the prior art, the present invention provides a new consumer rewards program that makes charitable donations based on consumer purchases and also funds business benefits programs. Wherein the same can be utilized for providing convenience for the user when making donations to local programs and organizations.

The present system and method provide the benefits of a customer loyalty program, a charitable fundraising program, and a pooled long-term investment asset program. It brings municipal governments, businesses, and individuals together to utilize commercial transaction profits to fund community projects and charitable causes. An administrator entity is established to oversee and administer the system and bring component organizations together. Municipal governments, businesses, and citizens enrolled in the program are tracked by the Administrative entity via one or more databases.

Consumers are provided with member accounts that link basic personal information about the consumer to a selected charitable organization, and loyalty program information. Cards are issued to each consumer that may provide indicia associated with the member account, or may have a machine readable means of identifying the consumer's member account. The card is presented at retailers and service providers at the point of sale. If the business is a program participant, a portion of the consumer's purchase price will be donated by the business to the program. This donation is split into three portions: 1) a first portion is donated to the charitable organization or municipal project associated with the consumer's member account; 2) a portion is sent to a retirement plan trust fund established for participating businesses; 3) a portion is attributed to the consumer's member account as a store credit for later purchases with the specific retailer. Thus the purchase price of consumer transactions dictates how much money will be donated by the business to the consumer's charity of choice, and the retirement plan fund. Consumers are incentivized to shop at participating businesses because a portion of their purchases will help community improvement projects, and will provide them with credits on later purchases.

Businesses participating in the program bear the responsibility of providing revenue flow to the charities and retirement plan fund based on individual consumer purchases. Compliance with this responsibility is tracked by the Administrative entity. Preferably, funds are automatically distributed at the time the transaction occurs to reduce the bookkeeping burden on businesses. For example, the consumer member card is swiped, or an account number entered by the clerk into a POS system, payment is rendered by the consumer, and upon completion of the transaction the system designates the appropriate apportionment of funds in its request to the consumer's bank. In an alternative embodiment, the portion of the funds reserved for the charity and retirement fund are sent to the Administrative entity to distribute.

The system incentivizes businesses to participate by establishing a retirement plan fund for participating businesses. A portion of consumer purchases made at participating businesses is paid into the fund over time, and can he used later as retirement income. As employees of participating businesses retire, they are able to take advantage of the long-term investment asset by receiving payments from the retirement plan fund. The long-term investment asset it underwritten by an insurer and a portion of the fund is invested by an investor selected by the fund Trustee. Returns on investments made with retirement fund capital are returned to the fund to ensure continued growth. Other benefits may also be offered to participating businesses such as a group health care plan that the employees can buy into. Pooling the participants as a group results in reduced health care plan rates and makes providing health care to employees a more affordable option than obtaining individual coverage.

Organizations falling within 26 U.S.C. §501(c) (hereinafter “Charities”) may be set up by the Administrator to fund municipal projects, or initiatives. Alternatively, pre-existing Charities may join the program to raise money for community causes. By way of example, a municipality may need to purchase new fire engine trucks for several communities and request that the Administrator assist with establishing a community charity that raises capital for truck purchases. In another example, the local Humane Society chapter may need to raise money for a new spay and neuter program, and joins the system as a Charity to meet their fundraising goals. A substantial portion of the capital received by the Charity must go to the specific project for which funding was solicited. A residual portion of the capital may be used by the Charity for general funding, overhead, or other projects. This allows participating Charities to take advantage of any leftover funds and reduces the need for creating a fundraising campaign for every project or initiative.

The system and method thus provide an easy and efficient way for citizens to “give back” to their communities by simply making purchases at participating businesses. Municipalities can take advantage of this untapped capital stream to fund projects that might otherwise go unfunded for the year. Because community members can select the charities they support, the fundraising system provides the municipality with a form of economic feedback about what programs are most important to community members. Programs and projects that are of particular importance to community members will be funded without the need for the municipality to raise taxes on all citizens.

It is therefore an object of the present invention to provide a new and improved charitable fundraising system that has all of the advantages of the prior art and none of the disadvantages.

It is another object of the present invention to provide a system and method for funding municipal programs and charitable organizations in individual communities, without necessitating a blanket tax increase.

Another object of the present invention is to provide a system and method that allows community members to make regular, nominal contributions to their selected charities and programs.

Yet another object of the present invention is to provide a system and method that incentivizes local business participation by establishing a retirement plan for participating businesses and by offering an increase in customer base.

Still another object of the present invention is to provide a system and method that reward a consumer for making purchases at participating businesses by providing the consumer with store credit.

A further object of the present invention is to provide a fundraising system where the amount of each donation is determined by the purchase price in a consumer transaction.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a general system diagram of an exemplary embodiment of the fundraising system and method.

FIG. 2 shows a flow chart diagram of an exemplary implementation of the consumer member account creation process.

FIG. 3 shows a flow chart diagram of an exemplary consumer transaction at a participating business.

FIG. 4 shows a flow chart diagram of the usage by a participating Charity of capital donations.

FIG. 5 shows a flow chart diagram of an exemplary municipal project charity creation and addition to the system.

FIG. 6 shows a flow chart diagram of an exemplary business enrollment process.

FIG. 7 shows a flow chart diagram of an exemplary retirement plan transaction process.

### DETAILED DESCRIPTION OF THE INVENTION

The present invention may be understood more readily by reference to the following detailed description of preferred embodiment of the invention. However, techniques, systems, and operating structures in accordance with the present invention may be embodied in a wide variety of forms and modes, some of which may be quite different from those in the disclosed embodiment. Consequently, the specific structural and functional details disclosed herein are merely representative, yet in that regard, they are deemed to afford the best embodiment for purposes of disclosure and to provide a basis for the claims herein, which define the scope of the present invention. It must be noted that, as used in the specification and the appended claims, the singular forms “a”, “an”, and “the” include plural referents unless the context clearly indicates otherwise. In the following description, for purposes of explanation, numerous specific details are set forth in order to provide a thorough understanding of the present invention. It may be evident, however, that the present invention may be practiced without these specific details. In other instances, well-known structures and devices are shown in block diagram form in order to facilitate describing the present invention.

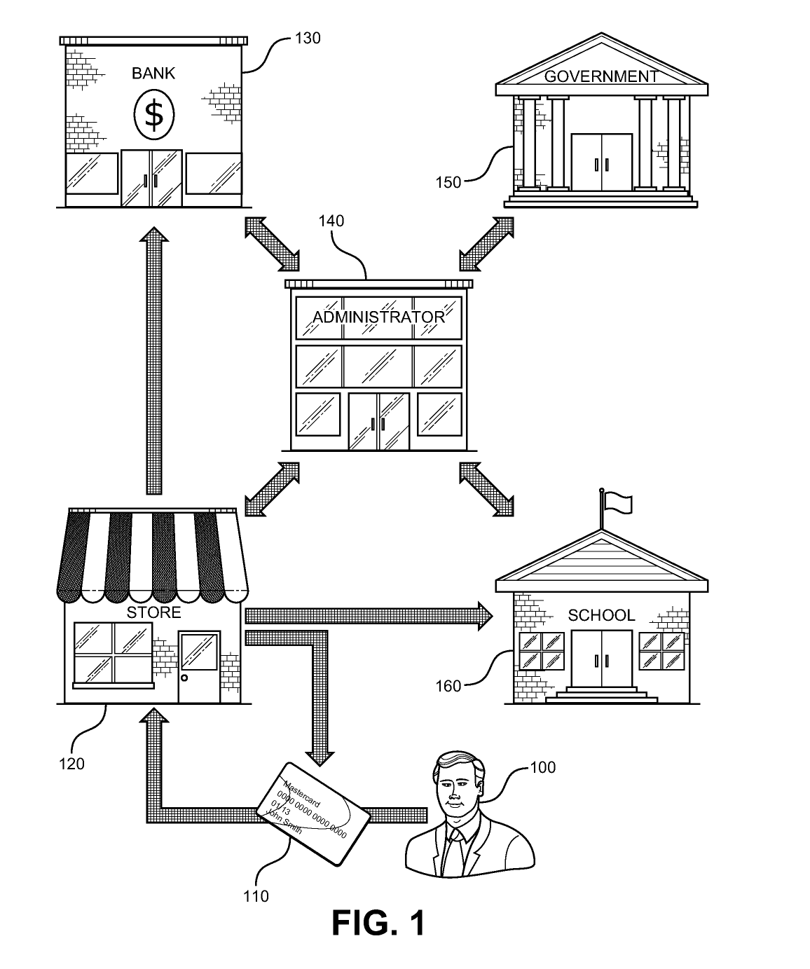

Referring now to FIG. 1, there is shown a representation of a basic embodiment of the fundraising system. The system is initiated and administered by an administrative entity 140. An administrative entity may be non-profit organizations or business. It brokers communication between municipal governments 150, charitable organizations 160, financial institutions 130, businesses 120, and individual community members 100. This collaboration provides a means for the commercial transactions of community members to be used as revenue streams for municipal projects and charitable causes.

The administrative entity maintains participant account data and issues membership cards 110 to individual members. The cards are associated with a member account that contains personal identifying information and a preferred charitable recipient. When the individual makes purchases at participating businesses, the card is presented so that the member's account may be accessed. Upon completion of a purchase predetermined portions of the purchase price are designated for 1) the Charity (26 U.S.C. §501(c) entity) indicated in the accessed member account; 2) a pooled retirement fund for participating businesses; 3) a consumer loyalty reward in the form of a store credit. Capital from the transaction is transferred to accounts associated with the Charity and retirement fund at one or more banks. The consumer reward credit is stored in the member account so that it can be accessed the next time the consumer presents their member card at the businesses.

Municipal governments can provide the administrative entity with a list of underfunded projects and programs for inclusion within the system. Likewise, local charitable organizations can opt in by requesting that the administrative entity enroll them in the system. In the embodiment illustrated in FIG. 1, the done is a public school. Public schools often lack the funds necessary to fund programs such as educational and vocational training for children with learning disabilities, academically gifted students, and physically disabled students. By way of example, the school can provide a regular request for community fundraising in the form or an annual, bi-annual, or quarterly report, to the municipality. The municipality passes these requests along to the administrative entity who establishes a charitable entity for the school. Donations made to the school are used to fund the requested projects. A small portion of the funds may also be used to fund other school needs. This permits schools to divert small amounts of revenue into small projects, thereby negating the need for requesting funding for those smaller projects. Participating community members can specify through the Administrative entity, which projects they would like their donations to fund. If a consumer wishes for their donations to go solely to the “teaching children with learning disabilities” project then their donations will be earmarked for that particular project. Alternatively, consumers can choose to donate to “all Oak park elementary school projects.” In an alternative embodiment, funding requests are made directly to the administrative entity rather than the municipality. This embodiment can reduce overhead and decrease the burden on the municipality of regularly participating in fundraising efforts.

In addition to funding municipal projects and local charities, the system also provides a retirement fund for participating businesses. A portion of the purchase price of participating consumer transactions is paid by the business into the retirement fund. Each business's contribution is tracked over time and reported to the business at intervals. Upon meeting predetermined plan requirements, the business owner and/pr his employees may receive payments from the fund. In a preferred embodiment the requirements will stipulate a retirement age or minimum number of years worked, though other options are contemplated. In a preferred embodiment, the fund is established as a trust with a designated trustee. The trustee may designate an investor to invest a portion of the trust into a diverse portfolio of financial products and assets. As a long-term investment, the fund should be underwritten by an underwriter of the trustee or the bank's choosing. In this way the system provides a long-term financial benefit to businesses that enroll in the plan, and donate to consumer selected charities, and honors consumer loyalty credits.

Other benefits may also be extended by the administrative entity to business participants. In one example, the administrative entity can work with health care providers to establish a group health plan that the businesses' employees can buy into at low rates. Health care plans for small businesses may be prohibitively expensive to the businesses alone. However, as a group the health care providers can offer far more reasonable rates to the collective employees. Life insurance, discounts on health club memberships, and other benefits are also contemplated for the employees of participating businesses. Thus the plan costs the business a portion of each transaction but provides a long-term benefit and some immediate benefits that the business might not otherwise be able to afford.

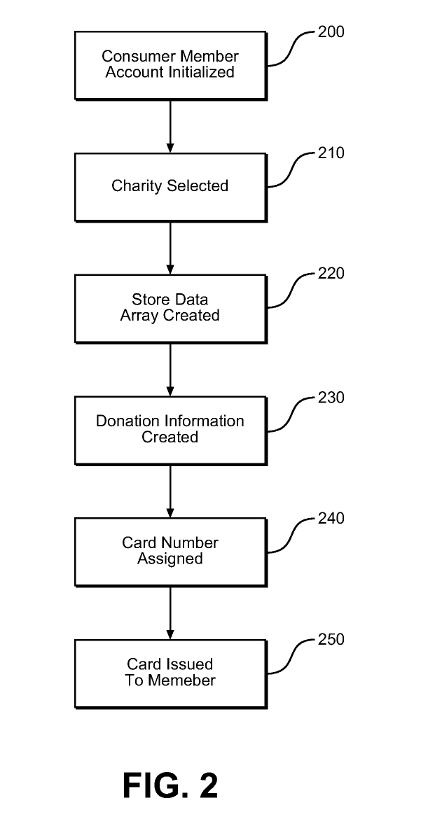

Referring now to FIG. 2, there is shown a flow chart of the member enrollment process. The administrative entity will maintain one or more databases containing account information and identifiers for all system participants. This includes individuals, businesses, and charitable organizations/projects. As participants enroll in the plan, their accounts are crated and their participating is tracked. Consumer Member accounts will contain at least data pertaining to name, contact information, member identifier, current selected charity, donative history, a list of loyalty rewards at participating businesses, and a donative summary for the current tax year. Business member accounts will contain at least data pertaining to name of enrolling party, business name, contact information, business member identifier, donative history, retirement fund contribution history, benefits plans enrollment, and donative history for the tax year. Charity member accounts include at least data pertaining to name of parent entity, contact information, a list of current projects and programs for which fundraising are active, notations on earmarking of funds for specific projects/programs, financial account routing information, a charity identifier, and donation receipt history, tax year donation information. The specific type of database or databases used will depend upon the needs of the particular system implementation. It will be obvious to one of ordinary skill in database integration and administration how to select appropriate database frameworks and integrate them with bank and business systems. To this point, it should also be obvious that data maintenance may actually be performed by multiple entities, and may be redundant. For example, banks will likely track contributions to the retirement fund over time and for the current taxable year. Thus, the administrative entity may elect to receive this information from the financial institution rather than tracking the information itself. Maintenance of data should not be limited to the exemplary embodiment described above, but should be understood to be versatile and flexible as understood by one of ordinary skill in the art.

Member enrollment may be accomplished by the member via an administrative entity website or by an administrative entity employee who manually inputs the user's information into a database interface. When a consumer enrolls in the system, the administrative entity uses the person's contact information to create a member account 200. The consumer selects a charity from the list of participating charitable entities 210. If the user enrolls via a website then this step can occur through the use of a drop down menu that displays participating charities. The list may be filtered based on the municipality or the user's zip code, in order to provide a list of participating organizations distributed throughout the city or those in a member's direct vicinity. After the member has selected a charity and confirmed their personal information, the account database creates a data array, linked list, or other data structure for storing information about the reward credits a consumer earns at participating businesses 220. A donation history data structure and current tax year donative summary field are also created 240 in association with the new account. Member identifiers such as a number, string of characters, coded image, or the like are assigned to the member account 240 and retained in the account information. Alternatively the account identifier may be assigned during account initialization. After all necessary information fields are created within the database, the account is finalized and a member card is printed and sent to the consumer 250. Member cards are presented at participating businesses to indicate that the purchase transaction will result in a donation by the business to the consumer's selected charity, and a business credit issued to the consumer's account.

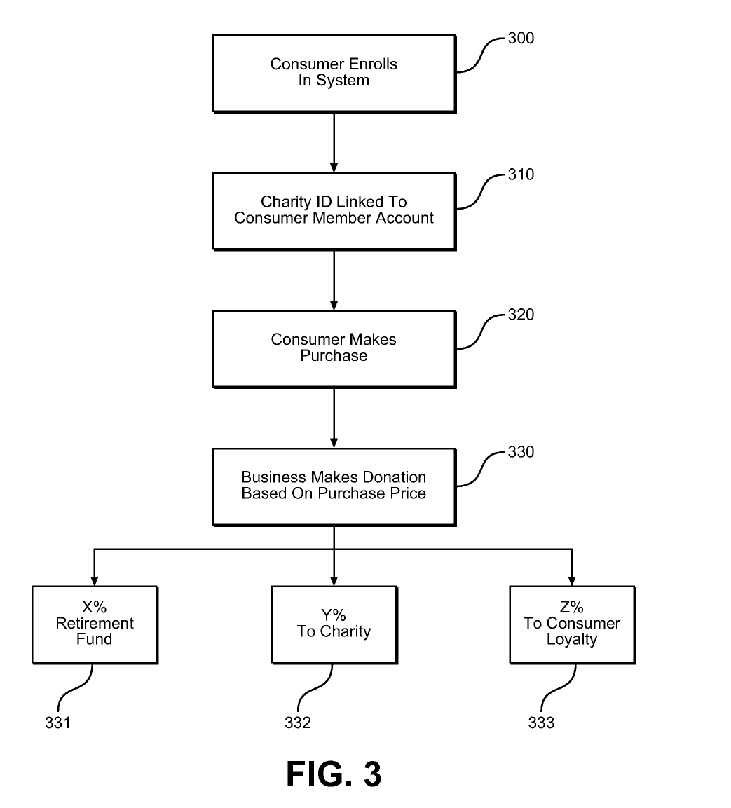

An example of the system's purchase transaction process is shown in the flow chart of FIG. 3. Once the user is enrolled in the system plan 300 and a charity identifier is properly linked to the consumer's member account 310, the consumer can begin making eligible purchases. Eligible consumer purchases are made 330 at participating businesses and require the presentation of a consumer's member account information. The member card may be similar to a credit card in form, and have a magnetic strip on the back that is readable by a POS card reader. The card should also display indicia on at least one side that corresponds to the consumer's member identifier. If the swipable strip cannot be read by the card reader, a store clerk can manually enter the member identifier information. In one embodiment the identifier may be a member number that is read from the magnetic strip when the card is swiped through a card reader. In another embodiment, the member identifier is a QR code that is scanned by a digital camera at the POS terminal.

The purchase price of the items is used to calculate the size of the donation a business makes in accordance with the system 330. A first portion, “Y” of the purchase price is donated by the participating business to the charity associated with the charity identifier in the consumer's member account 332. A second portion, “X” of the purchase price is contributed by the participating business to the retirement fund 331. A third portion, “Z” is retained by the business as income, but a corresponding amount is attributed to the user's member account in the form of a store credit. In an exemplary embodiment the charitable donation percentage is 9%, the retirement fund contribution is 2%, and the store credit is 4%. It is to be understood that these percentages may vary according to the specific implementation of the system and may be altered while the invention is in use, to adapt to changing market conditions and participant needs.

Further, the precise means of attributing the donated funds may vary according to system implementation. It is desired that the business's contribution to the charity and retirement plan are intercepted during the underlying purchase to the respective accounts. Thus, after a consumer presents their member card and a purchase is made, some of the money will go to the business's merchant account, some will go to the charity account, and some will go to the retirement fund account. This reduces the bookkeeping burden on the business and increases the likelihood of proper transfer reporting. However, it should be understood that the system may also be implemented in such a way that donation information is tallied by the business after each purchase, preferably within their POS system, and regular contributions are made to the appropriate charities and retirement fund. The administrative entity should perform compliance checks to ensure that proper reporting is maintained. The exact implementation of the attribution and clearing system is beyond the scope of this application and should be understood by one of ordinary skill in the art.

It is preferred that the administrative entity informs consumer members of participating businesses in their area. Emails, website updates, mass mailings and other forms of consumer contact may be used to inform members about participating businesses in their area. Returning to the aforementioned example of an elementary school Charity, the administrative entity may solicit new customers for a participating business by informing the school's parent teach association (PTA) that the business is a system participant and a portion of purchases made at the business will be donated to school programs. This is an effect way of bringing new customers to a participating business and increasing donations to the Charity. Administrative entities play a key role in communicating between types of system participants and brokering relationships. The more customers that are sent to a business, the more money will be raised.

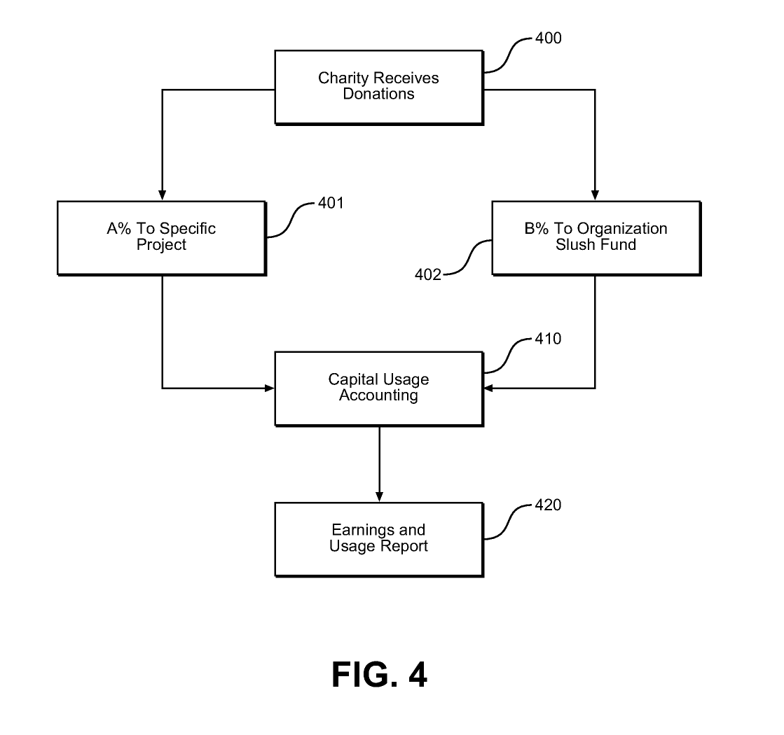

Referring now to FIG. 4, a flow chart diagram depicts the process of Charity intake of donated funds. Charitable organizations established by the administrative entity and pre-existing organizations will have bank account information on file with the administrative entity. Donations from eligible consumer purchases are deposited in the Charity bank account 400. The parent entity, a school, a police precinct, a local park, a local charity of the like, can use the funds in the account at specified intervals. The intervals may be set forth by the administrative entity or determined by the charities themselves. Examples of appropriate intervals are annual, bi-annual, quarterly and monthly. The appropriate interval period will likely depend on the nature of the program. Ongoing programs that require regular capital infusion such as vocational training for police officers with learning disabilities may be needed more often than a fund for annual spring planting in a local park. Restrictions on account access may be implemented by the bank holding the account, and accumulation reports provided at each interval so that the Charity knows how much money it has raised during the interval.

Flexibility with respect to use of raised funds is desirable within the system because it is difficult to predict the revenue return for any particular project. Community involvement, time of year, economic factors, and similar factors may cause larger than expected or smaller than expected returns. To this end, the system provides a percentage based rule for allocation of donated funds. A first portion, “A” of the funds should be used to fund the projects listed by the Charity to the administrative entity 401. A smaller second portion “B” may be used as needed by the parent entity, to pay for overhead costs, or fund smaller projects 402. The Charity should track its allocation and usage of donated funds 410 as best it can. Gathered information should be reported at intervals to the administrative entity 420. Administrative entities will check for compliance with system rules. In an exemplary embodiment, the percentage of funds that should be used on listed projects/programs is 75% and the percentage allocated to general use is 25%. These numbers are not intended to be limiting and should be understood as modifiable depending on the needs of the participants.

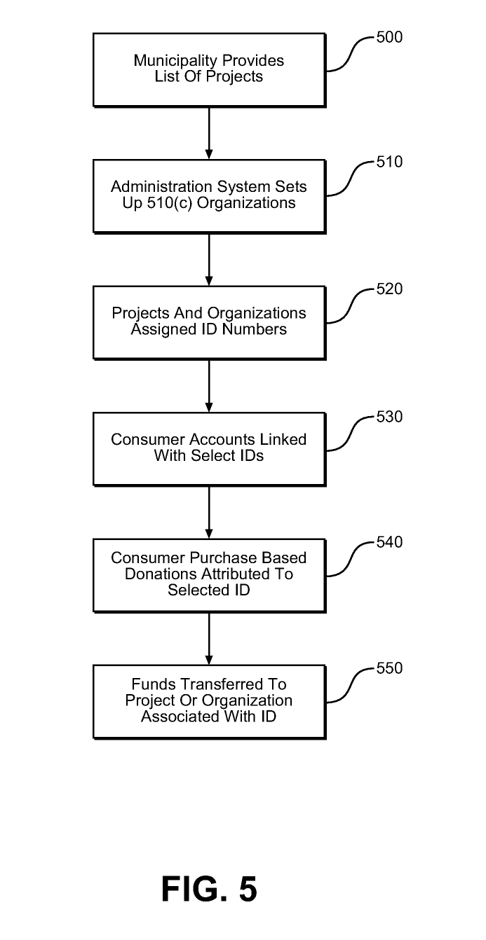

Turning now to FIG. 5 there is shown a flow chart disclosing the process of creating new revenue streams for underfunded municipal government programs and projects. It is preferred that the municipality provides the administrative entity with a list of programs and projects that need capital infusion 500. The administrative entity then assists the municipality or the program recipients with establishing a charitable organization and/or a bank account in the Charity's name 510. These Charities are assigned identifiers 520 that are maintained within an administrative entity database and linked to the specific charity bank accounts. Consumer member accounts can then be linked to these charities by including the charity identifier in the “selected charity” data field within the consumer member's account information. When the consumer makes an eligible purchase, the participating business will donate funds to the identified charity 550. The municipality can use the influx of revenue to assess what projects and programs are important to the community and which may be safely cut. This form of economic feedback is invaluable in city planning and budget allocations. The system and method thus helps municipalities make economic decisions about how to spend revenue on non-essential government programs. Essential government programs should be funded by tax income and other standard forms of government revenue generation.

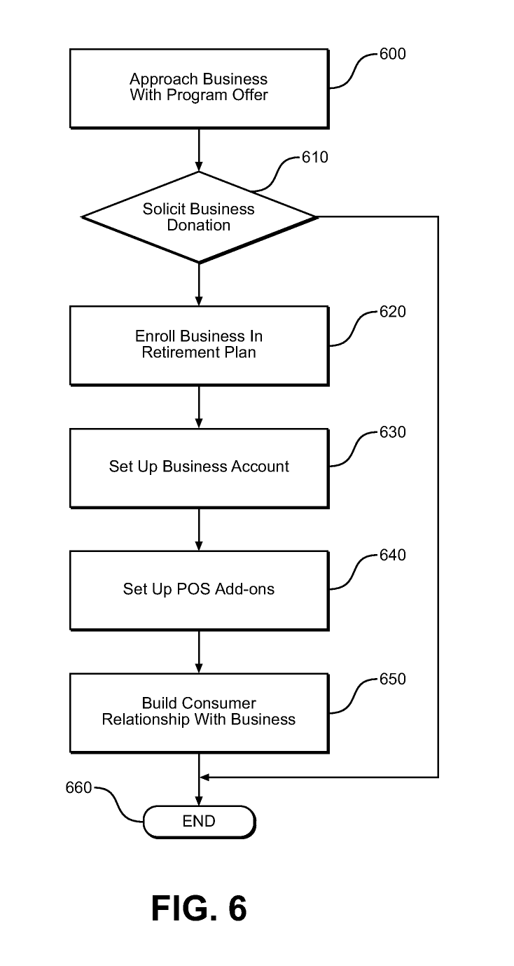

An exemplary embodiment of business enrollment in the plan is shown in FIG. 6 of the drawings. The administrative entity reaches out to local businesses to solicit system enrollment 600. This may be done through a variety of marketing means such as email, mass mailers, professional events, trade shows, door to door solicitation, and the like. To enroll in the system plan, the business contributes an initial capital payment to the administrative entity 610. If the administrative entity is a charitable organization, this payment will be a donation. Conversely, if the administrative entity is a business, the payment will be a one-time fee. Initial payments are contemplated in the range of 200.00 to 1,000 dollars, but they may be larger or smaller depending on the specific business and the market in which the business operates. These initial capital payments are used by the administrative entity to pay overhead costs and system maintenance expenses. It is desired that the precise allocation of the initial payments to administrative entity expenditures should be left to the discretion of the administrative entity. If the business owner refuses to make the initial capital payment, the administrative entity can choose to waive the payment or cancel enrollment of the business.

Businesses that contribute an initial payment to the fundraising system are enrolled in the participant business retirement fund program 620. The business may also be offered additional benefits in the form of group health insurance plans, medication discount cards, life insurance, and health club membership discounts. These benefits are optional and the business may opt out if they have no need of the offered benefits. The selection of offered benefits may include other benefits typically offered in employee benefits packages. The goal is to offer business participants the ability to provide employee benefits that they could not otherwise afford.

Business member accounts are created 630 for each participating business and include information regarding their retirement plan contribution history and donative history. The administrative entity provides guidance or assists the business in setting up any required add-ons or programs within the business's point of sale terminal 640. Such programs will facilitate accurate bookkeeping of charitable donations and retirement fund contributions based on consumer sales. As discussed above, a number of attribution methods may be employed, but the selected method should ensure business compliance with system rules.

As long as the business is a participant in the system, the administrative entity will assist in bringing new clients to the business. The administrative entity will produce marketing and build community relationships that bring consumers to participating businesses 650. In this manner, the administrative entity fosters community patronage of local businesses, increases business sales, and increases donations to participant charities. Businesses may leave the system 660 either by informing the administrative entity, closing down, or refusing to comply with donation requirements.

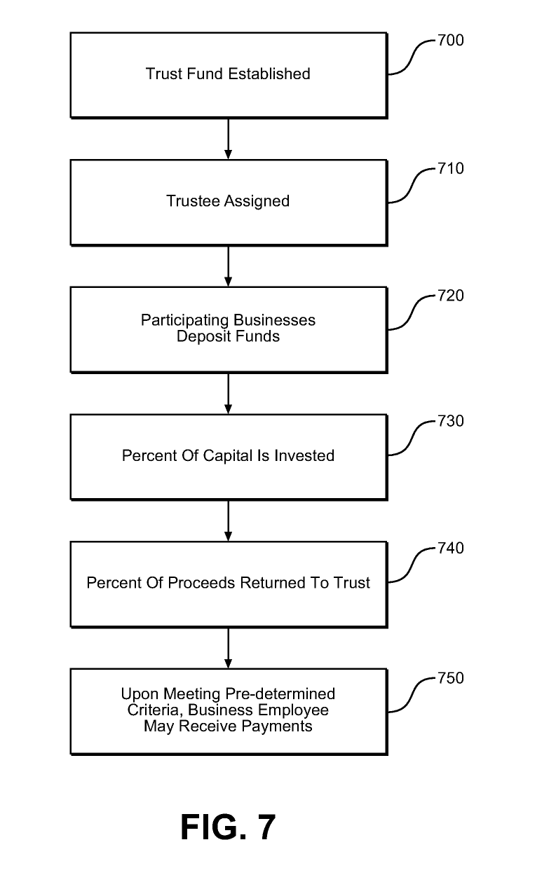

Referring finally to FIG. 7, there is shown a flow chart diagram of the retirement fund establishment and use process. The retirement fund is a pool capital long-term benefit asset for businesses participating in the system. A trust is the preferred means of retaining the capital so that a strict fiduciary duty is created in the fund trustee. Setup of the trust should be performed by attorneys or other legal entities having sufficient legal knowledge in the area of trusts and estates. One or more bank accounts will be created in the Trust's name. A separate account may be used to hold investment funds so that this capital is not intermingled with the trust's savings. An insurer is selected by the bank or Trustee to underwrite the benefit asset. In this way, the retirement plan trust fund (hereinafter “Trust”) is established 700. During the establishment of the Trust, a Trustee is appointed 710. The trustee may be a single person, a firm, or other entity.

Businesses participating in the plan contribute a pre-determined portion of the purchase price of eligible sales to the Trust 720. In an exemplary embodiment this amount is 2%, however this amount may vary over time or vary according to the implementation of the system. Each business's contribution history is retained by either the administrative entity or the bank, so that a business employee's share of retirement payments can be easily determined at any given point in time. Employees are entitled to Trust payments upon satisfaction of one or more factors such as attaining a certain age, completing a pre-determined number of years of service, or the like 750. The option of early withdrawal from the fund is left to the discretion of the fund creators. Likewise, the intervals at which payments are made to retired employees, and the formula for determining payment values is left to those persons who establish the fund. These choices will likely fall to the administrative entity, the bank and the Trust insurer. Pooled long-term benefit asset funds are known in the art and can be created and managed by one of ordinary skill.

A portion of the Trust's capital may be invested 730 by an investor or investment firm selected by the Trustee. Thus the Trust's capital reserves are divided into a saving portion and an investment portion. The saving portion should be larger than the investment portion to protect the integrity of the Trust's long-term reserves. Investment capital may be diversified across a portfolio as best determined by the Investor based on market considerations at the time each investment is made. Returns on these investments will be returned to the Trust, minus any Investor fees 740. It is desired, that sensible investing will promote growth of the fund and increased resources for payment of retirement benefits.

The method of the present invention involves the steps of creating a member account database; establishing a retirement plan trust fund; soliciting a listing of underfunded programs and projects from a municipality; soliciting charity organizations; creating a number of charitable organizations and associated bank accounts; assigning charity identifiers to the charities, enrolling businesses in the system; assigning the participating businesses unique identifiers; enrolling the participating businesses in the retirement plan trust fund; enrolling a number of community members; associating the community members with consumer identifiers; and issuing the community members membership cards. The community members then make purchases at the participating businesses using their membership card, and the businesses make donations based on the purchase price of the sale to selected charities and to the retirement plan trust fund. Variations on this method may be necessary to accommodate variations in the implementation of the system.

In use an individual goes to a participating business such as a restaurant, retailer, or service provider. Participation may be confirmed through a listing on the system website, by a communication between the administrative entity and the consumer or by indicia such as a sticker in the window of the business. The consumer selects items or services for purchase and approaches a point of sale (POS) terminal to check out. During the check out process, the consumer hands their membership card to the store clerk, who scans the card or enters identifying information into their terminal interface. After the consumer pays for the purchase, a first percentage of the purchase price is sent to a charity pre-selected by the consumer, a second portion is sent on the business's behalf to a retirement plan trust fund, and a third portion is calculated and attributed to the consumer's member account in the form of a store credit. In a preferred embodiment, a system website will permit members to check their accounts online and see how much money has been donated on their behalf.

The present invention is a system and a method for raising capital to fund charitable causes and underfunded municipal programs. Consumer purchases are tracked and a portion of the purchase price is donated by a participating business to the charity of the consumer's choice. Thus the more the community spends on commercial goods and services, the more revenue is generated for charities and programs. Businesses are also benefited in that they contribute small amounts overtime to a large retirement fund, and are offered several additional benefit plans. The system alleviates some of the strain on municipal governments to come up with ways to fund projects when their budgets are tight.

In a preferred embodiment the charity receiving donations during each purchase, is determined by the consumer. The consumer should be able to change their selected charity easily to accommodate changes in participating charities. By way of example, a person may be donating to the local animal shelter but may decide to switch to a program for teaching children with learning disabilities when such a program joins the system. The consumer, can do this by logging onto the system website, entering their account information and updating their donation preferences, or can contact the administrative entity directly to request a change in charity.

Alternatively, the participating businesses may select the charity they wish to support and any eligible purchases made by participating consumers will benefit that charity. In this embodiment, the business will select a charity to support when the business enrolls in the system. The administrative entity will associate a charity identifier with the business member account and ensure that funds donated by the business are attributed to the selected charity. Changes to the selected charity can be made by contacting the administrative entity. This should not be done frequently because a portion of the business's new customer base will be patronizing the business based on their charitable support and frequent changes in support might alienate customers.

In all embodiments of the system and method, it is desired that proper compliance monitoring and accounting procedures are implemented. Reports on fund usage, donation history, and the like should be generated at pre-determined intervals to ensure that local, state and federal tax laws are followed, and all fiduciary duties are met. Oversight of these elements of the system will fall to the administrative entity or an agent it designates.

An example of a basic implementation of the system will require at least one server maintained by the administrative entity. The server will have a central processing unit, at least one storage, a main memory, a network connection and a power source. One or more member account databases are stored on the storage and are used to maintain identifying information associated with user accounts of each type used in the system, i.e. consumers, businesses, charities. This server is in contact with individual businesses, so that member account information can be accessed during purchases.

One or more bank servers will also be in contact with the individual businesses and administrative entity to ensure proper routing of funds through the system. Point of service terminals located at each business will effect this communication and are also equipped to read membership cards issued by the administrative entity to consumer members. Information read off the membership card should provide sufficient information to permit the POS terminal to access information in the specific member's account at on the administrative entity server. All communication occurs over a network such as the internet. Basic implementation of the system is not limited to this configuration and it will be understood by one of ordinary skill in the art that variations are permitted.

It is submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A fundraising system, comprising:
an administrative entity having one or more servers, wherein said servers store at least one member dataset, and have a network connection;
a network;
a business member retirement fund;
at least one business member, having one or more point of sale terminals having a consumer account information input means and a network connection;
at least one charity member having a bank account and wherein routing information of said bank account is stored within said member database;
a plurality of consumer members;
a plurality of membership cards issued by said administrative entity to said consumer members, wherein said membership cards display an indicia associated with a consumer member identifier.

2) The system of claim 1, wherein said member database contains information about a charity selected by a consumer member for donation.

3) The system of claim 1, wherein said consumer account information input means is a magnetic strip reader.

4) The system of claim 1, wherein said consumer account information input means is a digital camera.

5) The system of claim 1, wherein presentation of said member ship card by a consumer to said business member, at the time of a purchase transaction, results in said business member making a donative monetary transfer to said charity member bank account.

6) The system of claim 5, wherein the value of said donative monetary transfer is a percentage of a purchase price of said purchase transaction.

7) The system of claim 1, wherein presentation of said member ship card by a consumer to said business member, at the time of a purchase transaction, results in said business member making a contribution to said retirement plan trust fund.

8) The system of claim 7, wherein the value of said contribution is a percentage of a purchase price of said purchase transaction.

9) The system of claim 1, wherein presentation of said member ship card by a consumer to said business member, at the time of a purchase transaction, results in a store credit being applied to said consumer member's account.

10) The system of claim 9, wherein the value of said store credit is a percentage of a purchase price of said purchase transaction.

11) The system of claim 1, wherein said charity member is a charitable entity associated with a municipal government program.

12) A method of establishing a municipal fundraising program, comprising the steps of:
creating a member account database;
establishing a retirement plan fund for business members of the program;
enrolling one or more charitable organizations in the program as charity members;
enrolling businesses in the program as business members;
enrolling the participating businesses in the retirement plan fund;
enrolling a plurality of individual consumer members;
associating the community members with consumer identifiers;
issuing the community members membership cards to be used when making purchases at said business members.

13) A method of making a consumer transaction at a business participating in a fundraising program, comprising the steps of:
displaying a consumer membership card during a purchase;
inputting a member indicia on said membership card into a point of sale terminal;
providing funds in the amount of a purchase price;
completing said purchase;
donating a first portion of said funding to a charity member of the program;
contributing a second portion of said funding to a retirement plan fund;
crediting a third portion of said funding to said membership card as a store credit.

14) The method of claim 13, wherein said first, second, and third portions are pre-determined.

15) The method of claim 13, wherein said charity member is pre-selected by a consumer member of the program and is associated with said membership card.

16) The method of claim 13, wherein said charity member is pre-selected by a business member of the program.
